(19) United States
(12) Patent Application Publication
(10) Pub. No.: US 2020/0175544 A1
(43) Pub. Date: Jun. 4, 2020

(54) METHODS AND SYSTEMS FOR DETERMINING ADVERTISING REACH BASED ON MACHINE LEARNING

(71) Applicant: Rovi Guides, Inc., San Jose, CA (US)

(72) Inventors: Steven Bennett, Somerville, MA (US); Randall Kelley, Belmont, MA (US); Xiaoxi Xu, Chestnut Hill, MA (US)

(21) Appl. No.: 16/698,421

(22) Filed: Nov. 27, 2019

Related U.S. Application Data
(63) Continuation of application No. 14/985,150, filed on Dec. 30, 2015, now abandoned.

(51) Int. Cl. G06Q 30/02; G06N 20/00

(52) U.S. Cl. CPC G06Q 30/0244; G06Q 30/0201; G06N 20/00

(57) ABSTRACT

Methods and systems are provided for determining advertising reach based on machine learning. In particular, a reach calculator is provided to determine reach for advertisement campaigns in real time through the use of machine learning. The reach calculator increases the speed at which reach calculations can be done by using a trained machine learning model and a set of aggregated features as opposed to using a direct calculation approach that directly analyzes a massive amount of user data.

### BACKGROUND

In conventional systems, advertisements (e.g., television commercials) often appear with content (e.g., television programming). In many cases, advertisers may wish to know how effective their advertisements are. For example, advertisers may be interested in determining the reach (e.g., the unique number of users exposed) of an advertisement or advertisement campaign (e.g., a series of advertisements made during a particular time period in which the timing and placement are coordinated).

Unfortunately, determining the reach (e.g., the number of unique users exposed to an advertising campaign) based on direct calculation techniques is prohibitive when a large user data set (e.g., 10 million users) is involved. For example, directly calculating reach (i.e., performing the required calculations) for such large data sets would take an inordinate amount of time, and cannot adequately be determined in real time. Thus, advertisers are prohibited from dynamically altering advertisement campaigns, running analyses to determine the most effective advertisement campaigns, or directly optimizing advertising campaigns for maximal reach. Moreover, as content providers continue to evolve and multiply, the amount of content available (e.g., webcasts, on-demand media assets, broadcasts, etc.) and the size of user data sets (e.g., what content was watched when and by whom) used continues to increase, and challenges in calculating reach will only increase.

### SUMMARY

Accordingly, methods and systems are provided herein to solve the aforementioned problems. For example, a reach calculator configured as described herein may determine reach for advertisement campaigns in real time through the use of machine learning. In particular, the reach calculator increases the speed at which reach calculations can be done by using a trained machine learning model and a set of aggregated features as opposed to using a direct calculation approach that directly analyzes a massive amount of user data.

For example, as part of the training process, the machine learning model may be continually calibrated based on a comparison of a simulated reach determined using the currently-trained machine learning model and a sample reach determined using a user data set. Additionally or alternatively, based on the comparisons, the reach calculator may continually refine aggregated features (e.g., criteria selected as indicative of an exposure of a unique user to an advertisement), and/or combinations thereof, to determine which combination of aggregated features currently provides the most accurate estimate of reach. Further, the reach calculator may provide dynamic, fast and on-demand reach calculations.

The reach calculator disclosed herein reduces the amount of data that needs to be processed to compute a reach, thereby allowing the reach calculator to provide reach calculations faster.

In some aspects, the reach calculator may retrieve a user data set. For example, the user data set may include user media viewing data, which may be information about the past viewing histories of users who may be subscribed to cable or satellite television service. Additionally or alternatively, the user data set may further include programming data, which may be information related to each of the channels offered by a media provider, or information about each program offered. The reach calculator disclosed herein may generate a set of aggregated features that is predictive of a reach of one or more advertising campaigns. For example, the reach may be a number of unique users who are exposed to an advertising campaign. Further, the set of aggregated features may be extracted from the user data set.

The reach calculator disclosed herein may develop a machine learning model used to estimate reach. For example, the reach calculator may retrieve a sample user data set from a user data set based on a selected sample size, and determine a sample reach based on the set of aggregated features and that sample user data set. Further, using a machine learning model, the reach calculator may determine a simulated reach based on the same set of aggregated features and the same selected sample size. For example, the selected sample size may be determined using a chosen percentage of the total number of users or subscribers of a media service provider (e.g., cable television operator).

The reach calculator may then determine whether the difference between the simulated reach and the sample reach exceeds a threshold, and if that is the case, the reach calculator and/or a user may calibrate the machine learning model. The calibration may include establishing a mathematical formula that defines a relationship between the simulated reach and the set of aggregated features. For example, the calibration of the machine learning model may involve the modification of one or more parameters that set the machine learning model such that the difference between the simulated reach and the sample reach is reduced. For example, each of these parameters is a variable that influences the relationship between the simulated reach and the set of aggregated features. Further, the machine learning model may be developed by repeatedly calibrating the machine learning model until the difference between the simulated reach and the sample reach is less than or equal to the threshold. Moreover, the reach calculator and/or a user may further develop the machine learning model based on different sample sizes and sample user data sets. The reach calculator and/or a user may also further develop the machine learning model based on different aggregated features.

The reach calculator may determine, on an on-demand basis, an estimate of the reach of an advertising campaign based on the set of aggregated features and the developed machine learning model. Further, the reach calculator may determine whether an advertising campaign is optimal based on the determined estimate of the reach. To determine whether an advertising campaign is optimal, for example, the reach calculator may compare the determined estimate of the reach to a desired estimate of the reach. The desired estimate of the reach may be set by an advertising campaign designer or by a machine. If the result of the comparison shows that the difference between the determined estimate of the reach and the desired estimate of the reach is less than or equal to an acceptable threshold, then the reach calculator may determine that the advertising campaign is optimal. However, if the difference exceeds an acceptable threshold, then the reach calculator may determine that the advertising campaign is not optimal. When the advertising campaign is not optimal, the reach calculator and/or the user may adjust the advertising campaign by, for example, adjusting its specifications. For example, an advertising campaign may be adjusted by increasing the number of advertisements included in the advertising campaign and/or modifying the schedules of the included advertisements. Additionally or alternatively, the reach calculator and/or the user may continually adjust the advertising campaign until the difference between the estimate of the reach and the desired estimate of the reach is within an acceptable threshold.

It should be noted that the systems, methods, apparatuses, and/or aspects described above may be applied to, or used in accordance with, other systems, methods, apparatuses, and/or aspects.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen generated by a media guidance application in accordance with some embodiments of the disclosure;

FIG. 2 shows another illustrative example of a display screen generated by a media guidance application in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of an illustrative process for developing a machine learning model to estimate reach in accordance with some embodiments of the disclosure;

FIG. 6 is pseudocode of an illustrative process for developing a machine learning model to estimate reach in accordance with some embodiments of the disclosure;

FIG. 7 is a diagram showing that the development of a machine learning model is performed in the backend and that the calculation of an estimate of reach is performed in the frontend in accordance with some embodiments of the disclosure; and

FIG. 8 is a flowchart of an illustrative process for determining, on an on-demand basis, an estimate of the reach based on the set of aggregated features and the developed machine learning model in accordance with some embodiments of the disclosure.

### DETAILED DESCRIPTION

Methods and systems are provided for determining advertising reach based on machine learning. In particular, the reach calculator disclosed herein increases the speed at which reach calculations can be performed by using a trained machine learning model and a set of aggregated features. The fast reach calculator may rapidly estimate the reach for an advertising campaign as opposed to using a direct calculation approach that directly analyzes a massive amount of user data.

By obviating the need to analyze a massive amount of user data used to compute reach, the reach calculator as disclosed herein may significantly reduce the time required to process and analyze data. Further, by using a constantly-developing machine learning model and a set of aggregated features selected and designed for a particular advertising campaign, the reach calculator disclosed herein may rapidly estimate reach on an on-demand basis and in real time. Further, because the development of the machine learning model is performed in the backend, the fast on-demand reach calculation, which is performed independently in the frontend, is not adversely impacted. Accordingly, a user is more likely to utilize and adopt the reach calculator as disclosed herein.

As referred to herein, the term “user data set” may refer to a set of data that contain information related to usage or consumption of media assets by one or more users. A media asset may be a television program, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. A media asset may be a single episode of a television program. A media asset may also be a standalone movie. Further, a media asset may consist of multiple episodes of a television program. A media asset may also consist of multiple seasons of a program. Further, a media asset may also consist of multiple movies of a movie series.

A user data set may include one or more user media viewing profiles. A user media viewing profile may be a record or history of all programs consumed by a user. For example, a user media viewing profile may be part of the account information of a subscriber of a cable television service. The user media viewing profile may be stored locally in a user equipment device. The media viewing profile may also be stored remotely at the cable operator's servers. In that case, the media viewing profile may be accessible by the user through an online transfer. The media viewing profile, which may provide valuable information about each user's entertainment experience and behavior to the cable operator, may also be readily accessible to the cable operator. In some cases, there may be millions of user profiles that are stored and maintained by a cable operator. These user profiles together may provide powerful and valuable insight about, for example, the viewing patterns of the majority of users or a selected group of users. Further, the user profiles may provide the cable operator useful information on, for example, exactly how many users watched a certain advertisement on a certain channel during a specific time in the past. For example, each of the user profiles may provide a minute-by-minute viewing history of each user profile. Such profiles may provide the information that is required to ascertain, for example, the number of the advertisements that reached a user during a specific time.

Additionally or alternatively, a user data set may also include channel information and/or program information. Channel information may include, for example, information on the type (e.g., sports channel; kids channel; news channel) of each channel that a user had previously watched. Program information may include, for example, the popularity rating of each program that a user had previously watched. Further, a user data set may include metadata associated with each user viewing profile. For example, such metadata can include data on the title, duration, actors/actresses, genre, rating and/or identifications of associated advertisements of each program watched. Moreover, a user data set may also be stored and organized in one or more databases.

Moreover, a sample of a user data set may be taken from the full user data set for the purposes of developing a machine learning model. For example, one thousand (1,000) user profiles may be sampled from the full user data set that contains one million (1,000,000) user profiles.

As referred to herein, an “advertising campaign” may refer to a set or a series of advertisements. Such advertisements may be part of a planned or coordinated publicity campaign intended to reach one or more segments of the subscribers of a cable service to promote one or more products or services. For example, an advertising campaign may also convey a campaign theme, which is followed by each of the advertisements contained in the same campaign. For example, an advertising campaign may contain a large number of advertisements (e.g., one hundred (100) advertisements). Further, each advertisement of an advertising campaign may be purposefully selected to be part of the advertising campaign. Each of such advertisements may be selected based on a type of the product or service being publicized. Each advertisement may also be selected in relation to other advertisements of the same advertising campaign. For example, a manufacturer of kids' toys may sponsor an advertising campaign in which only advertisements for the toys sold by that manufacturer are included. Alternatively, each of such advertisements may be selected based on multiple types of products or services being publicized. For example, a conglomerate may sponsor an advertising campaign to raise the general awareness of the company. In that case, the designed advertising campaign may include advertisements of different types of products or services (e.g., medical equipment, home appliances, airplane engines, hydroelectric equipment, internet technology consulting, and financial services all offered by one company).

Further, one or more advertisements of an advertising campaign may be placed in between programs being watched by a user, or in between segments of a program being watched by a user. Additionally or alternatively, one or more advertisements of an advertising campaign may also be embedded in programs being watched by a user. For example, such an advertisement may occupy a portion of the display where the program itself is also being played.

Additionally or alternatively, an advertising campaign may also be specified by various requirements. For example, a requirement may be that certain advertisements be presented at specific days and times. For instance, one group of the advertisements contained in a particular advertising campaign may be required to be presented during only weekday prime times (e.g., 7:00 PM to 10:00 PM), and another group of the advertisements may be required presented in the afternoons of weekends (e.g., 3:00 PM to 6:00 PM on Saturdays and Sundays).

As referred to herein, “reach” may refer to the number of users who are exposed to an advertising campaign. This number may also be the unique number of users who are exposed to an advertising campaign. Reach may be calculated using direct calculation techniques. For example, by going through a user data set (e.g., each user's viewing profile or history) that is maintained by a cable operator, the number of unique users who watched the advertisements of an advertising campaign can be obtained by assessing whether each user was tuned to a particular channel where each advertisement was presented at a specific time. If so, the user may be considered as being exposed to the particular advertisement, and counted. Each user's viewing profile may contain a minute-by-minute viewing history, which may provide the necessary information to assess which channel was tuned to and at what time by the user. Computing a reach by going through every user profile may amount to a very time-consuming task that may not be realized in real time or on an on-demand basis.

Further, the reach for a specific advertising campaign may be estimated based on a developed machine learning model and a set of aggregated features extracted from a user data set for the advertising campaign. To illustrate, an advertising campaign may be designed to promote a health club chain to a young adult population, and specified to use available sports channels to broadcast the designated advertisements. In that case, if the developed machine learning model establishes a linear function between the number of users exposed to at least one advertisement of the advertising campaign and the average of the popularity ratings (aggregated features) of all sports programs on all sports channels, then an estimate of the reach of this campaign may be determined.

As referred to herein, a “feature” may refer to an attribute of an advertisement. A feature may be predictive of the reach of an advertisement. For example, an advertisement may promote a video game and target an adolescent population at a frequency of one presentation of the advertisement per hour in each selected television channel. In that case, a feature may be the average of the popularity ratings of primetime (e.g., 7:00 PM to 8:00 PM) programs from all of the selected television channels during which that advertisement was presented.

As referred to herein, a “set of aggregated features” may refer to features specifically generated or selected for an advertising campaign for the purposes of estimating reach. Such features may be predictive of the reach of the advertising campaign. A set of aggregated features may be generated or selected based on the specifications (or characteristics) of a particular advertising campaign. For example, an advertising campaign may have an objective to promote a luxury car maker's various models to a mid-aged population, and may specify a series of twenty (20) different advertisements to be included in the advertising campaign, a late evening broadcast time range (10:00 PM to midnight) every day of the week, a group of five (5) major network channels selected for the advertisement broadcasting, and a frequency of at least one of the advertisements being broadcasted every fifteen (15) minutes per selected channel. Based on these specifications of the advertising campaign, a set of aggregated features may be extracted from a user data set that is maintained by a media provider (e.g., a cable operator). To illustrate based on the foregoing example, based on information extracted from the user data set, the popularity ratings of all 10:00 PM to midnight programs from the five channels during which the different advertisements were presented may be obtained. Such popularity ratings may be some of the aggregated features that may be predictive of a reach for the advertising campaigns. Further, the average of such popularity ratings may be calculated to generate another feature that is predictive of a reach.

Further, a set of aggregated features may be prepared in the backend in advance of the estimate of reach calculations. This may prevent operations performed in the backend (e.g., generation of aggregated features) from interfering with the operations performed in the frontend (e.g., estimate of reach calculations). Additionally or alternatively, a reach calculator may continually refine aggregated features and/or combinations thereof in order to determine which aggregated features or combination of aggregated features currently provide the most accurate estimate of reach.

As referred to herein, a “machine learning model” may be a model or a method to predict or estimate behaviors or results based on some data. A machine learning model may be developed by teaching a computer or a machine to keep improving predictions and estimations. For example, a machine learning model may be employed to discover patterns, relationships or correlations among various data such as reach, times of media consumption, channels and programs watched, media user attributes, ratings of programs, and the types of shows during which advertisements are presented. A machine learning model may use historical data about past events or action to detect one or more patterns in order to predict future events. Additionally, a machine learning model may include supervised learning, unsupervised learning or reinforcement learning techniques. Further, a machine learning model may establish one or more mathematical formulae or algorithms that define relationships among various data.

A machine learning model may be used to determine an estimate of the reach of an advertising campaign. For example, a sample user data set may be obtained from a large user data set such that the data used to develop or train the machine learning model may become more manageable. A sample user data set may be obtained by taking a random sample of a certain selected sample size. For example, a sample user data set may include the user viewing profiles of 5% of all of the users of a cable operator. The selection of the 5% of the users whose user viewing profiles are sampled may be performed randomly. Then, a sample reach of the sample user data set may be calculated to reflect the actual number of users from the selected 5% of users who were exposed to advertisements that match a set of aggregated features. Then, a simulated reach based on the set of aggregated features and the selected sample size may be determined using the machine learning model.

The machine learning model may be subsequently calibrated continually when the difference between the simulated reach and the sample reach exceeds a threshold until that difference diminishes to be less than or equal to the threshold. For example, the machine learning model may be continually calibrated by modifying one or more parameters of the machine learning model with the aim to improve the model such that the difference between the simulated reach and the sample reach may be reduced during every iteration. For example, each parameter may be a variable that affects the behavior of the machine learning model, and may influence the relationship between the simulated reach and the set of aggregated features.

A machine learning model may provide a linear relationship for estimating a reach based on the average of the ratings of the programs during which the advertisements contained in a particular advertising campaign are presented. In that case, an estimate of the reach may be obtained by applying a linear function to the average of the ratings. Further, even though a developed machine learning model may be developed using a sample user data set that covers a small percentage of all users (e.g., all customers of a cable operator), the developed machine learning model may be expanded or extrapolated to estimate the reach of an advertising campaign that is targeted at all users.

As referred to herein, “metadata” may be data that provides information about other data. Metadata may also contain multiple data fields related to different information. For example, metadata may provide information on the identification, type, content, purpose, time duration, parental control rating and/or other pertinent attributes of a particular program watched by a user. In some embodiments, metadata itself may be stored in memory. Further, metadata may be stored and organized in one or more databases.

The reach calculator disclosed herein may retrieve a user data set. In some embodiments, a user data set may cover data related to the usages or consumptions of media assets by all of the users who are subscribed to the service of the media provider (e.g., a cable operator). The retrieved user data may include user media viewing profiles, which may be comprehensive records that keep track of the information about every user's media consumption history. These user profiles together may provide information about, for example, the viewing patterns of the majority of users or a selected group of users. Further, the user profiles may provide the cable operator useful information on, for example, exactly how many users watched a certain advertisement on a certain channel during a specific time in the past. For example, each of the user profiles may provide detailed viewing history of each user profile. Thus, user viewing profiles included in the user data set may provide the information that is required to ascertain, for example, the number of the advertisements that reached a user during a specific time. Moreover, a user data set may also include channel information and/or program information, which may provide useful information used to generate an aggregated set of features.

There may be multiple ways for the reach calculator to receive a user data set. For example, when a user data set may be stored remotely in one or more databases maintained by a cable operator, the reach calculator may retrieve the user data set remotely through the internet.

The reach calculator disclosed herein or an advertising campaign designer may generate a set of aggregated features that is predictive of the reach of advertising campaigns. In some embodiments, a set of aggregate features is specifically generated for an advertising campaign for the purposes of estimating a reach. For example, a set of aggregated features may be generated based on the specifications (or characteristics) of a particular advertising campaign. Additionally, a set of aggregated features may be extracted from a user data set, which may, for instance, include user viewing profiles, channel information, and program information. For example, an advertising campaign may have an objective to promote a coffee maker's various coffee products to a young adult population, and may specify ten (10) different advertisements to be included in the advertising campaign, an early morning broadcast time range (6:00 AM to 8:00 AM) every weekday, and a group of three (3) major network channels selected for the advertisement broadcasting. Based on these specifications of the advertising campaign, a set of aggregated features may be extracted from a user data set that is maintained by a media provider (e.g., a cable operator). To illustrate, based on information extracted from the user data set, which may contain historical viewing data of a pool of users (e.g., subscribers of a cable service), the average of the numbers of all advertisements actually seen by each user per minute from 6:00 AM to 8:00 AM during every weekday on all three channels may be obtained. The numbers of all advertisements actually seen by each user per minute may be some of the aggregated features that may be predictive of a reach for the advertising campaign. Further, the average of these numbers may be calculated to generate another feature that is predictive of the reach.

Further, the generation of the set of aggregated features and the development of the machine learning model may be all performed in the background (or backend), in advance of the calculations of estimates of reach. This arrangement may increase the efficiency of the overall performance of the reach calculator, and may prevent operations performed in the background (the generation of the set of aggregated features and the development of the machine learning model) from interfering with the operations performed in the frontend (e.g., calculations of the estimates of reach). In some embodiments, the generation of a set of aggregated features may be based on a user selection. In that case, based on a sample user data set, a designer of an advertising campaign may manually select, for example, the program popularity ratings and/or the numbers of all advertisements seen by all users within a specified time as the aggregated features. In some other embodiments, the generation of the set of aggregated features may be based on a machine selection. In that case, the reach calculator may automatically select a set of aggregated features based on feedback output from the machine learning model.

The reach calculator disclosed herein may develop a machine learning model. A machine learning model may be used to determine an estimate of the reach of one or more campaigns. For example, the reach calculator may retrieve a sample user data set from a large user data set. The size of such a sample user data set may become more manageable to be analyzed. The size of such a sample user data set may be determined using a percentage of a total number of users or subscribers of a cable service. Further, a sample user data set may be obtained by taking a random sample of a certain selected sample size. Such a sample user data set, which may be reduced in size by many orders of magnitude when compared to the full user data set, may be used to efficiently develop or train a machine learning model. For example, a sample user data set may include the data related to user viewing profiles of 10% of all of the users of a cable operator. The selection of the 10% of the users whose user viewing profiles are sampled may be performed randomly or based on certain criteria (e.g., equal proportions of selections of users from each age group; equal proportions of selections of users from each geographical region). Next, a sample reach for the sample user data set may be determined based on a set of aggregated features. To illustrate, a sample reach may be calculated by going through the user viewing profiles of all of the selected 10% of users covered in a sample user data set and based on a set of aggregated features. A generated set of aggregated features may be, for example, popularity ratings of programs during which certain advertisements contained in the advertising campaign are presented. In that case, the reach calculator may analyze each user view profile from the sample user data, and may perform a tally of every unique user who watched a program matching one of the popularity ratings during which an advertisement contained in the advertising campaign is presented.

The reach calculator may then determine a simulated reach based on the set of aggregated features and the selected sample size using the machine learning model. The machine learning model may be subsequently calibrated continually when the difference between the simulated reach and the sample reach exceeds a threshold until that difference is reduced to be less than or equal to the threshold. To illustrate using the previous example where the generated set of aggregated features may be popularity ratings of programs during which certain advertisements contained in the advertising campaign are presented, a simulated reach may be determined using the machine learning model that takes into account the popularity ratings of programs during which certain advertisements contained in the advertising campaign are presented, and the selected sample size by which the sample user data set is retrieved to determine the sample reach. For instance, because the aggregated features may be popularity ratings of programs in this example, the machine learning model may establish a function that is dependent on the program's popularity ratings. Such a function may be, for example, linear, exponential, or hyperbolic in nature. Further, to determine the simulated reach, the machine learning model is applied for a smaller, manageable sample size by which the sample user data set is retrieved.

Moreover, the reach calculator may calibrate the currently-existing machine learning model when the difference between the simulated reach and the sample reach exceeds a threshold. In some embodiments, the calibration of the machine learning model includes establishing a mathematical formula or algorithm that defines a relationship between the simulated reach and the set of aggregated features. For example, to calibrate the machine learning model, the reach calculator may modify one or more parameters of the machine learning model with the aim to improve the model such that the gap between the simulated reach and the sample reach is reduced. In some embodiments, each parameter is a variable that influences the relationship between the simulated reach and the set of aggregated features. Further, modifications of parameters may be performed iteratively, recursively or by a trial and error technique. Further, a machine learning model may be calibrated as many times as necessary to narrow the difference between the simulated reach and the sample reach to be less than or equal to an acceptable threshold. Moreover, because the machine learning model may be developed or trained using a small and manageable set of data (the sample user data set), each calibration of the machine learning model may be performed efficiently.

In some embodiments, the machine learning model may be further developed using new sample sizes and new sample user data sets. For example, the reach calculator may retrieve a new sample user data set from the user data set based on a new selected sample size. Then, the reach calculator may determine, using the machine learning model, a new simulated reach based on the set of aggregated features and the new selected sample size. A new sample reach based on the new sample user data set may then also be determined. Further calibration of the machine learning model may be performed when the difference between the new simulated reach and the new sample reach exceeds the threshold.

A reach calculator may apply the developed machine learning model to determine, on an on-demand basis, an estimate of the reach of an advertising campaign based on the set of aggregated features and the developed machine learning model. For example, the set of aggregated features may be the ratings of the programs during which the advertisements included in the advertising campaign are presented. The developed machine learning model may establish a mathematical relationship (e.g., a quadratic function; a natural exponential function) between the estimate of the reach and the average of these ratings (aggregated features). Thus, the reach calculator may apply this machine learning model and may rapidly determine an estimate of the reach for this advertising campaign. As another example, the set of aggregated features may be the times of the day during which the advertisements included in the advertising campaign are presented. The difference (another aggregated feature) between each of these presentation times and a prime time (e.g., 8:00 PM) may be established, and then a numerical average (one other aggregated feature) of the values representing these established differences may be determined. In that case, the developed machine learning model may establish another mathematical relationship (e.g., an inverse function) between the estimate of the reach and the numerical average of the values of the time differences. Thus, the reach calculator may apply this machine learning model and may rapidly determine an estimate of the reach for an advertising campaign.

Further, even though the machine learning model may be developed using a sample user data set that is retrieved from the full user data set and covers data related to a small percentage (e.g., 0.1%, or 1,000 users out of 1 million users) of all users covered in the full user data set, the developed machine learning model may be expanded or extrapolated to estimate a reach of an advertising campaign that is targeted at all users. For example, a machine learning model developed based on a small selected sample size may apply a corresponding multiplier when determining an estimate of a reach for an advertising campaign targeted at the entire user pool (e.g., all subscribers of a cable service).

In some embodiments, the reach calculator may determine whether an advertising campaign is optimal by determining a difference between a determined estimate of the reach and a desired estimate of the reach. When it is determined that the advertising campaign is not optimal because that difference is, for example, more than a predetermined threshold value, then the advertising campaign may be adjusted. For example, the advertising campaign may be adjusted at least by a number of advertisements included in the advertising campaign, advertisement frequencies, advertisement schedules, and advertisement channels. To illustrate, by increasing the number of advertisements included in the advertising campaign, the users may be more exposed to these advertisements, thereby increasing the estimate of the reach. As another illustration, an advertising campaign may be adjusted by modifying the advertisement schedules (e.g., placing advertisements closer to or during prime times). For instance, advertisements placed during prime times (7:00 PM to 10:00 PM during weekdays) may be watched by more users than those placed outside prime times, thereby increasing the estimate of the reach. Similarly, by increasing the advertisement frequencies (e.g., increasing the number of times of the included advertisements that are shown per minute on different channels), more users may be exposed to these advertisements, thereby increasing the estimate of the reach. As yet another illustration, the reach calculator and/or the user may adjust the advertising campaign by changing the channels used to disseminate the included advertisements. Further, the reach calculator and/or the user may adjust the advertising campaign by increasing the total number of channels used to disseminate the included advertisements.

In some other embodiments, the reach calculator and/or the user may continually adjust the advertising campaign until the difference between the estimate of the reach and the desired estimate of the reach is within an acceptable threshold. Further, a desired estimate of the reach may be specified by a designer of an advertising campaign or selected by the reach calculator.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

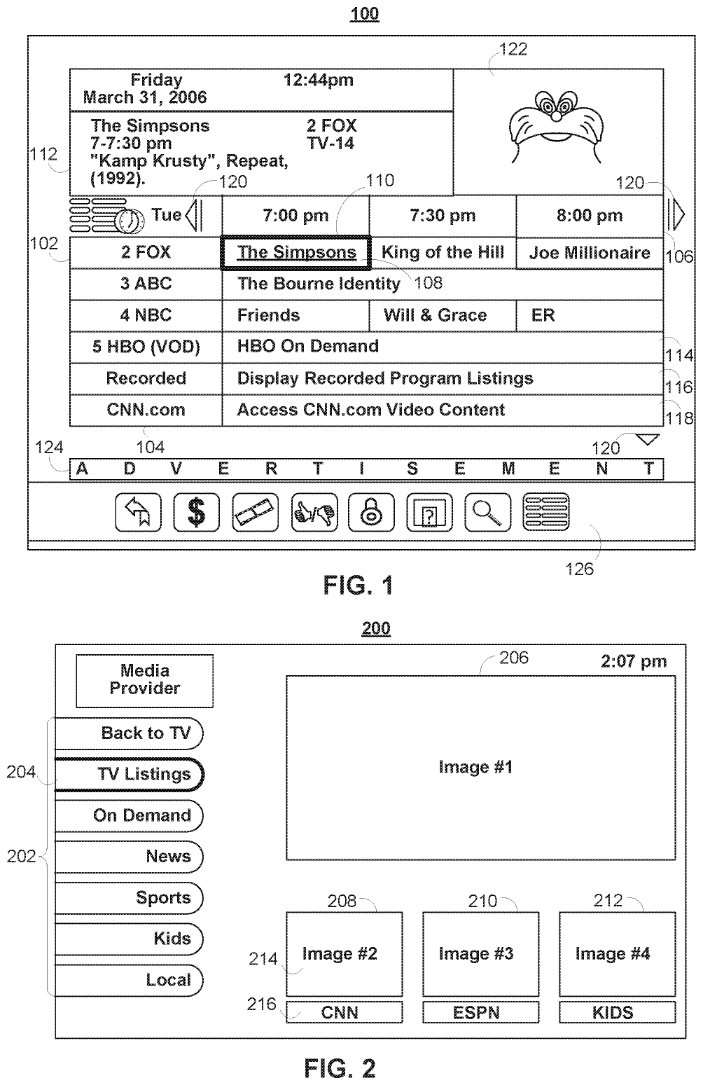

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

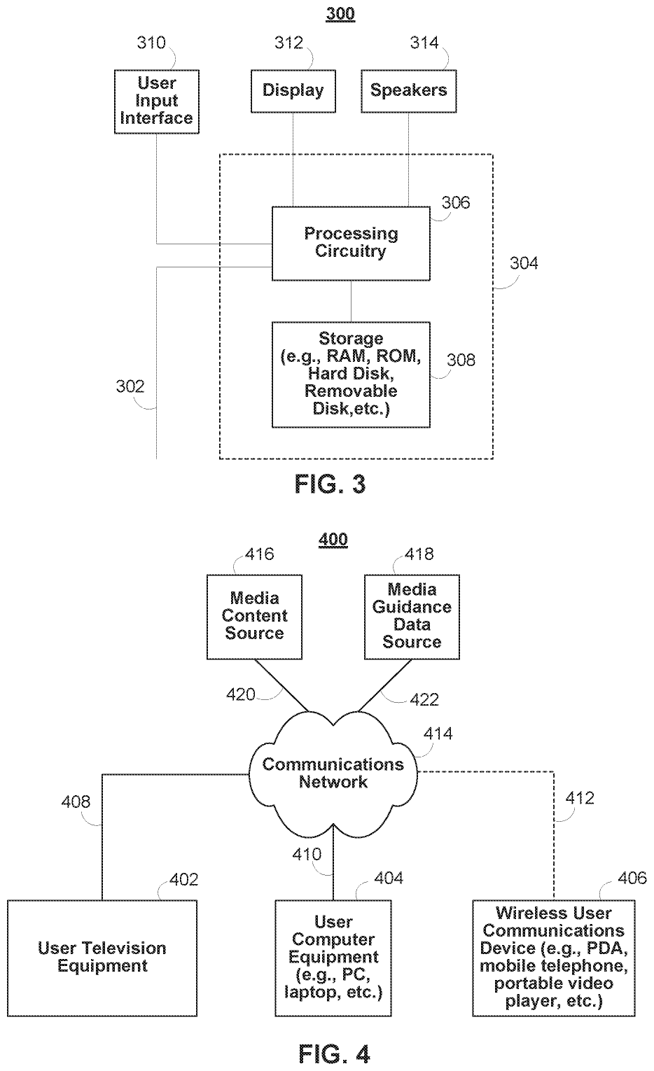

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

As referred to herein, the term “in response to” refers to initiated as a result of. For example, a first action being performed in response to another action may include interstitial steps between the first action and the second action. As referred to herein, the term “directly in response to” refers to caused by. For example, a first action being performed directly in response to another action may not include interstitial steps between the first action and the second action.

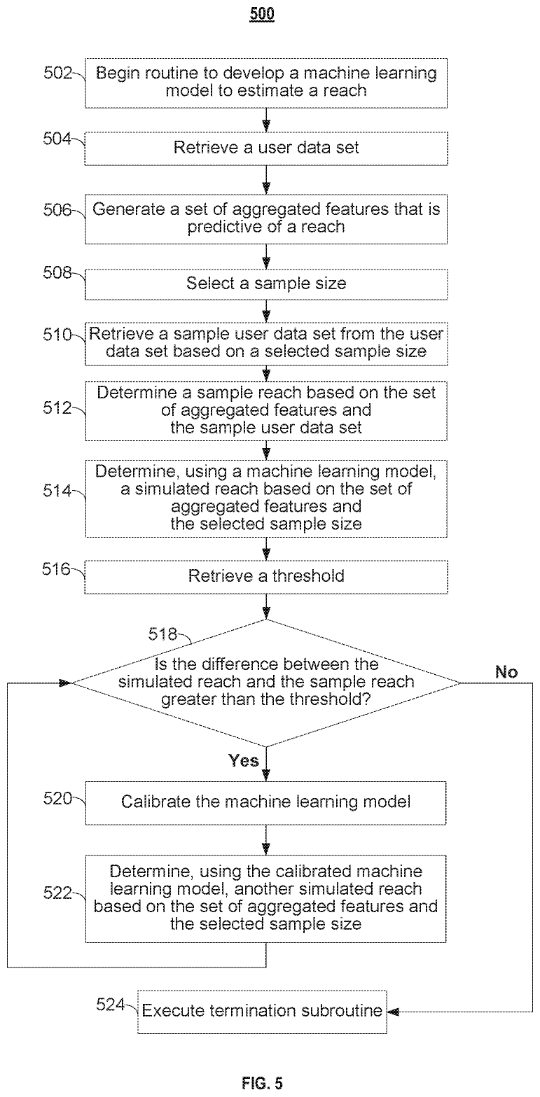

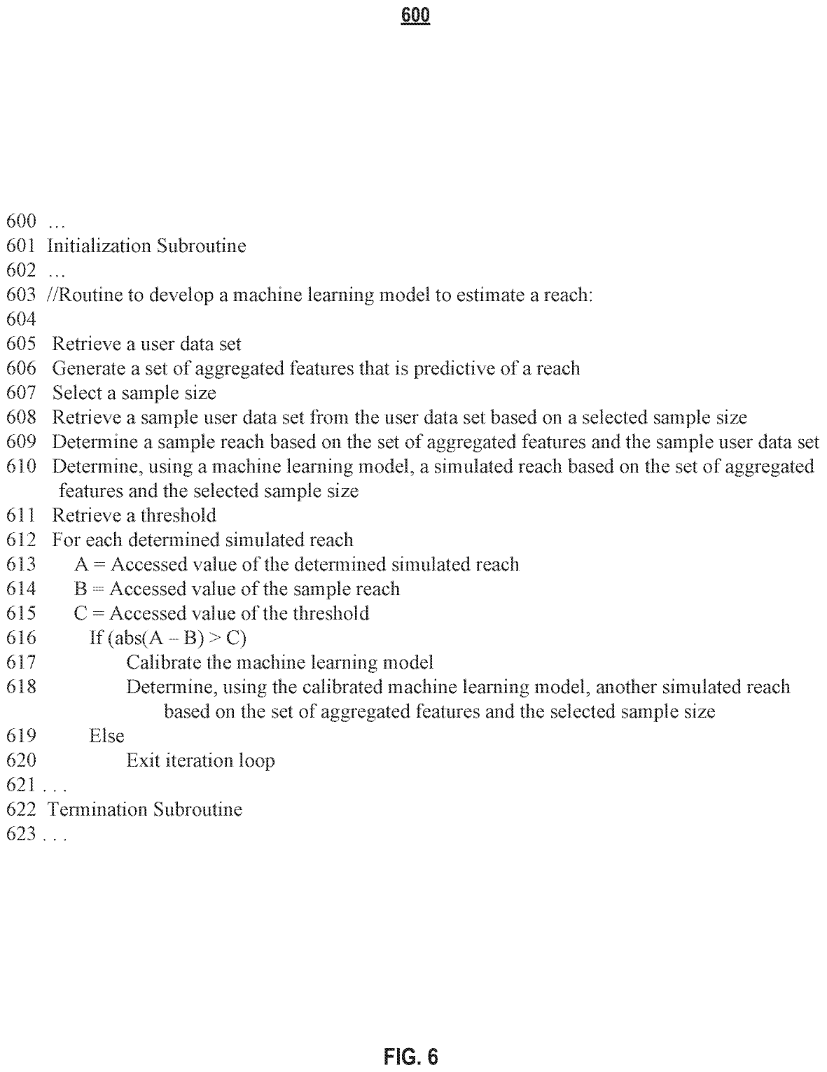

FIGS. 5 and 6 present a process for control circuitry (e.g., control circuitry 304) to develop a machine learning model to estimate a reach in accordance with some embodiments of the disclosure. In some embodiments, process 500 may be encoded onto a non-transitory storage medium (e.g., storage device 308) as a set of instructions to be decoded and executed by processing circuitry (e.g., processing circuitry 306). Processing circuitry may in turn provide instructions to other sub-circuits contained within control circuitry 304, such as the tuning, video generating, encoding, decoding, encrypting, decrypting, scaling, analog/digital conversion circuitry, and the like.

The flowchart in FIG. 5 describes a process implemented on control circuitry (e.g., control circuitry 304) to develop a machine learning model to estimate reach in accordance with some embodiments of the disclosure.

At step 502, the process to develop a machine learning model to estimate reach begins. In some embodiments, this may be done either directly or indirectly in response to a user action or input (e.g., from signals received by control circuitry 304 or user input interface 310). For example, the process may begin directly in response to control circuitry 304 receiving signals from user input interface 310, or control circuitry 304 may prompt the user to confirm his or her input using a display (e.g., by generating a prompt to be displayed on display 312) prior to running process 500.

At step 504, control circuitry 304 proceeds to retrieve a user data set. In some embodiments, control circuitry 304 may receive a single primitive data structure that contains the user data set. In some embodiments, the user data set may be stored as part of a larger data structure, and control circuitry 304 may retrieve data from the user data set by executing appropriate accessor methods. In some other embodiments, a user data set may be contained in a database stored locally (e.g., on storage device 308) prior to beginning process 500. The user data set may also be accessed by using communications circuitry to transmit information across a communications network (e.g., communications network 414) to a database implemented on a remote storage device (e.g., media guidance data source 418).

At step 506, control circuitry 304 proceeds to generate a set of aggregated features that is predictive of reach. In some embodiments, control circuitry 304 may receive a single primitive data structure that contains the set of aggregated features. In some embodiments, the set of aggregated features may be stored as part of a larger data structure, and control circuitry 304 may retrieve one or more features from the set of aggregated features by executing appropriate accessor methods. In some other embodiments, a set of aggregated features may be contained in a database stored locally (e.g., on storage device 308) prior to beginning process 500. The set of aggregated features may also be accessed by using communications circuitry to transmit information across a communications network (e.g., communications network 414) to a database implemented on a remote storage device (e.g., media guidance data source 418). Further, the generation of aggregated features may be performed by an advertising campaign designer or a reach calculator.

At step 508, control circuitry 304 proceeds to select a sample size used to retrieve a sample user data set. In some embodiments, control circuitry 304 may receive a single primitive data structure that represents the value that represents a sample size. In some embodiments, the value may be stored as part of a larger data structure, and control circuitry 304 may retrieve the value by executing appropriate accessor methods to retrieve the value from the larger data structure.

At step 510, control circuitry 304 proceeds to retrieve a sample user data set from the full user data set based on the selected sample size. In some embodiments, control circuitry 304 may receive a single primitive data structure that contains the sample user data set. In some embodiments, the sample user data set may be stored as part of a larger data structure, and control circuitry 304 may retrieve data from the sample user data set by executing appropriate accessor methods. In some other embodiments, a sample user data set may be contained in a database stored locally (e.g., on storage device 308) prior to beginning process 500. The sample user data set may also be accessed by using communications circuitry to transmit information across a communications network (e.g., communications network 414) to a database implemented on a remote storage device (e.g., media guidance data source 418).

At step 512, control circuitry 304 determines a sample reach based on the set of aggregated features and the sample user data set. For example, control circuitry 304 may call a function to go through each member (e.g., a user viewing profile) of the sample user data set and to determine whether the particular user was exposed to one or more advertisements included in the advertising campaign. If the function returns true, then that user may be counted towards the sample reach.

At step 514, control circuitry 304 determines, using a machine learning model, a simulated reach based on the set of aggregated features and the selected sample size. For example, control circuitry 304 may call a function to select the appropriate machine learning model based on the generated set of aggregated features to generate a simulated reach for the selected sample size.

At step 516, control circuitry 304 proceeds to retrieve a threshold used to gauge whether a simulated reach is adequate when compared to a sample reach. In some embodiments, control circuitry 304 may receive a single primitive data structure that represents the value that represents the threshold. In some embodiments, the value may be stored as part of a larger data structure, and control circuitry 304 may retrieve the value by executing appropriate accessor methods to retrieve the value from the larger data structure.

At step 518, control circuitry 304 proceeds to compare the simulated reach and the sample reach to determine whether their difference is greater than the threshold. Control circuitry 304 may call a comparison function (e.g., for object-to-object comparison) to compare the value that represents the simulated reach to the value that represents the sample reach.

At step 520, control circuitry 304 proceeds to calibrate the machine learning model when the difference between the simulated reach and the sample reach is greater than the threshold. For example, control circuitry 304 may call a function to modify one or more parameters of the machine learning model.

At step 522, control circuitry 304 determines, using a machine learning model after the calibration in step 520, a new simulated reach based on the set of aggregated features and the selected sample size. For example, control circuitry 304 may call a function to select the appropriate machine learning model based on the generated set of aggregated features to generate a new simulated reach for the selected sample size. Then, control circuitry 304 proceeds to loop back to step 518 to determine whether the difference between the new simulated reach and the sample reach is still greater than the threshold. If the difference is still greater than the threshold, then, control circuitry 304 repeats steps 520 and 522. However, if the difference is less than or equal to the threshold, then control circuitry 304 proceeds to step 524.

At step 524, control circuitry 304 runs a termination subroutine.

It is contemplated that the descriptions of FIG. 5 may be used with any other embodiment of this invention. In addition, the descriptions described in relation to process 500 may be done in alternative orders or in parallel to further the purposes of this invention using multiple logical processor threads, or process 500 may be enhanced by incorporating branch prediction. Furthermore, it should be noted that process 500 may be implemented on a combination of appropriately configured software and hardware, and that any of the devices or equipment discussed in relation to FIGS. 3-4 could be used to implement one or more portions of the process.

The pseudocode in FIG. 6 describes a process to develop a machine learning model to estimate a reach in accordance with some embodiments of the disclosure. It will be evident to one skilled in the art that the process described by the pseudocode in FIG. 6 may be implemented in any number of programming languages and a variety of different hardware, and that the style and format should not be construed as limiting, but rather as a general template of the steps and procedures that would be consistent with code used to implement some embodiments of this invention.

At line 601, control circuitry 304 runs a subroutine to initialize variables and prepare to develop a machine learning model to estimate a reach. For example, in some embodiments control circuitry 304 may copy instructions from a non-transitory storage medium (e.g., storage device 308) into RAM or into the cache for processing circuitry 306 during the initialization stage.

At line 605, control circuitry 304 retrieves a user data set. In some embodiments, the user data set may be stored in memory of the local device. In some other embodiments, the user data set may be stored on a network using servers.

At line 606, control circuitry 304 generates a set of aggregated features that is predictive of a reach. In some embodiments, the set of aggregated features may be stored in memory of the local device. In some other embodiments, the user data set may be stored on a network using servers.

At line 607, control circuitry 304 selects a sample size used to retrieve a sample user data set. In some embodiments, the sample size may be stored in memory of the local device.

At line 608, control circuitry 304 retrieves a sample user data set from the user data set based on a selected sample size. In some embodiments, the sample user data set may be stored in memory of the local device. In some other embodiments, the sample user data set may be stored on a network using servers.

At line 609, control circuitry 304 determines a sample reach based on the set of aggregated features and the sample user data set.

At line 610, control circuitry 304 determines, using a machine learning model, a simulated reach based on the set of aggregated features and the selected sample size.

At line 611, control circuitry 304 retrieves a threshold used to gauge whether the simulated reach is adequate when compared to the sample reach. In some embodiments, the threshold set may be stored in memory of the local device.

At line 612, control circuitry 304 iterates through a loop. This loop may be implemented in multiple fashions depending on the choice of hardware and software language used to implement the process of FIG. 6; for example, this may be implemented as part of a “for” or “while” loop.

At line 613, control circuitry 304 retrieves the value of the determined simulated reach. In some embodiments, this retrieved value may be stored in memory. The control circuitry 304 may convert the value into a format that it can later use for comparison.

At line 614, control circuitry 304 retrieves the value of the sample reach. In some embodiments, this retrieved value may be stored in memory. The control circuitry 304 may convert the value into a format that it can later use for comparison.

At line 615, control circuitry 304 retrieves the value of the threshold. In some embodiments, this retrieved value may be stored in memory. The control circuitry 304 may convert the value into a format that it can later use for comparison.

At line 616, control circuitry 304 evaluates whether the absolute difference between the value (“A”) of the simulated reach and the value (“B”) of the sample reach is greater than the threshold. This is achieved by, for example, comparing these values.

If the condition being evaluated at line 616 is satisfied, then, at line 617, control circuitry 304 will execute a subroutine to calibrate the machine learning model. Then, control circuitry 304 will proceed to line 618 where, using the calibrated machine learning model, another (new) simulated reach is determined based on the set of aggregated features and the selected sample size. Subsequently, control circuitry 304 will proceed to loop back to line 612 to repeat the process for the new simulated reach.

If the condition being evaluated at line 616 is not satisfied, then, control circuitry 304 causes the process to exit the loop and proceed to line 622.

At line 622, control circuitry 304 runs a termination subroutine after process 600 has performed its function.

It will be evident to one skilled in the art that process 600 described by the pseudocode in FIG. 6 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, the conditional statement may be replaced with a case-switch.

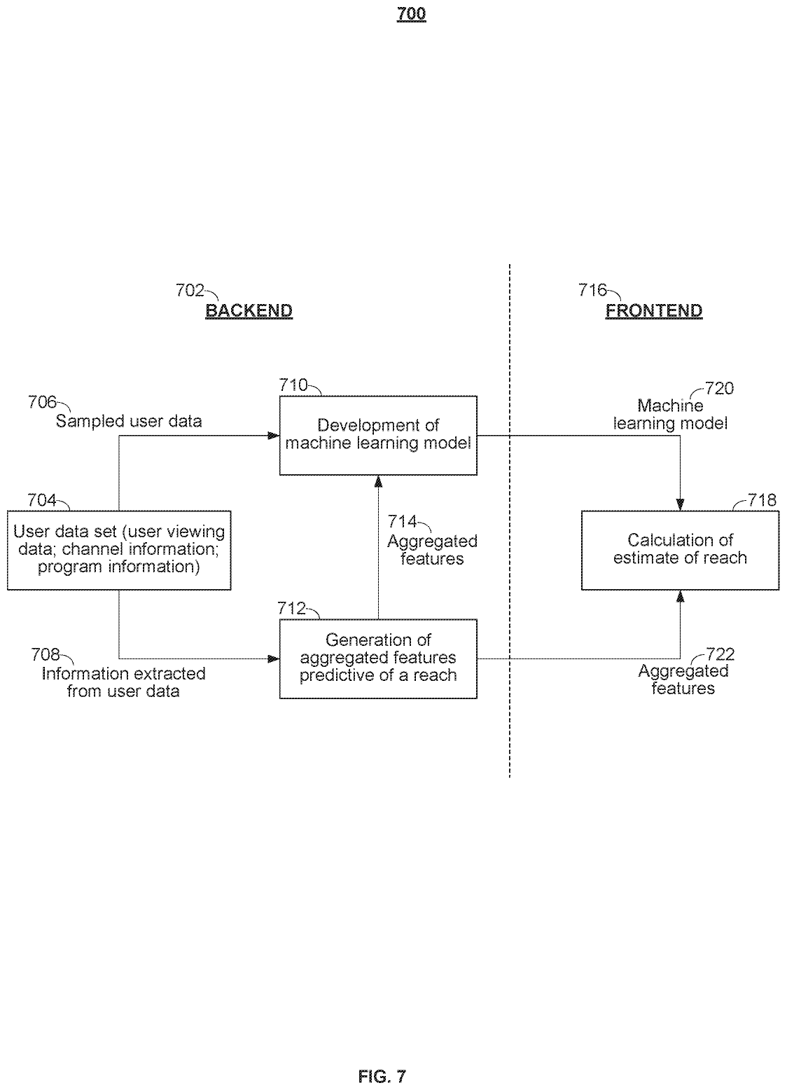

FIG. 7 describes the development of a machine learning model that is performed in the backend and the calculation of an estimate of reach that is performed in the frontend in accordance with some embodiments of the disclosure.

In FIG. 7, the generation of aggregated features predictive of a reach 712 and the development of machine learning model 710 are shown to be performed in the “BACKEND” 702. On the other hand, the calculation of estimate of reach 718 is performed in the “FRONTEND” 716.

As shown in FIG. 7, in the “BACKEND” 702, the generation of aggregated features predictive of a reach module 712 receives sampled user data 706 that are retrieved from the full user data set 704, which includes user viewing data, channel information, and program information. Moreover, the generation of aggregated features predictive of a reach module 712 receives information extracted from user data 708 from the full user data set 704.

As shown in FIG. 7, in the “FRONTEND” 716, the calculation of estimate of reach module 718 applies machine learning model 720 and aggregated features 722.

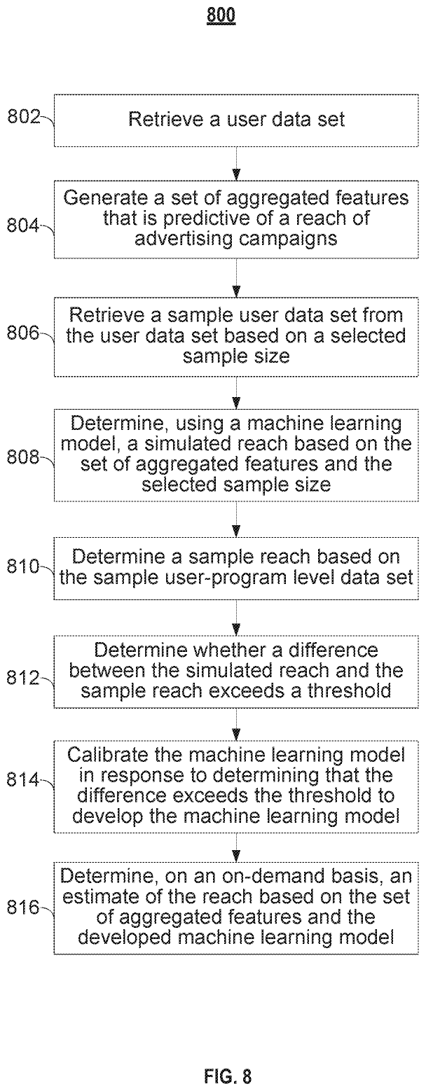

FIG. 8 is a flowchart of an illustrative process for determining, on an on-demand basis, an estimate of the reach based on the set of aggregated features and the developed machine learning model in accordance with some embodiments of the disclosure. It should be noted that process 800 or any step thereof could be performed on, or provided by, any of the devices shown in FIGS. 3-4.

At step 802, a reach calculator proceeds to retrieve (e.g., via control circuitry 304 (FIG. 3)) a user data set. In some embodiments, the retrieved user data set may be stored as part of a larger data structure, and control circuitry 304 may later retrieve data from the user data set by executing appropriate accessor methods. The control circuitry 304 may store such a user data set into one or more databases, which may be located locally or remotely.

At step 804, a reach calculator proceeds to generate (e.g., via control circuitry 304 (FIG. 3)) a set of aggregated features that is predictive of the reach of advertising campaigns.

At step 806, a reach calculator proceeds to retrieve (e.g., via control circuitry 304 (FIG. 3)) a sample user data set from the user data set based on a selected sample size. In some embodiments, the retrieved sample user data set may be stored as part of a larger data structure, and control circuitry 304 may later retrieve data from the sample user data set by executing appropriate accessor methods. The control circuitry 304 may store such a sample user data set into one or more databases, which may be located locally or remotely.

At step 808, a reach calculator proceeds to determine (e.g., via control circuitry 304), using a machine learning model, a simulated reach based on the set of aggregated features and the selected sample size.

At step 810, a reach calculator proceeds to determine (e.g., via control circuitry 304) a sample reach based on the sample user-program level data set.

At step 812, control circuitry 304 proceeds to determine whether a difference between the simulated reach and the sample reach exceeds a certain threshold. Control circuitry 304 may call a comparison function (e.g., for object-to-object comparison) to compare the value that represents the simulated reach and the value that represents the sample reach.

At step 814, control circuitry 304 proceeds to calibrate the machine learning model in response to determining that the difference exceeds the threshold to develop the machine learning model.

At step 816, control circuitry 304 proceeds to determine, on an on-demand basis, an estimate of the reach based on the set of aggregated features and the developed machine learning model.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 8.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the methods and systems described herein may be performed in real time. It should also be noted, the systems and/or methods described above may be applied to, or used in accordance with, other systems and/or methods.

1-50. (canceled)

51. A method for providing real-time reach estimation calculations via a machine learning model, comprising:
retrieving a reduced user data set having a sample size from a full user data set comprising media consumption data for a plurality of users;
generating, using control circuitry, a set of aggregated features that is predictive of a reach estimation of unique users who are exposed to an advertising campaign during media consumption;
developing the machine learning model by:
determining, using the control circuitry, a sample reach calculation, wherein the sample reach calculation is based on the set of aggregated features and the reduced user data set;
generating a simulated reach calculation using a selected machine learning model, implemented on the control circuitry, comprising one or more parameters, wherein the machine learning model is selected based on the set of aggregated features and the sample size; and
determining, using the control circuitry, whether the difference between the sample reach calculation and the simulated reach calculation exceeds a predetermined threshold;
in response to the determination that the difference between the sample reach calculation and the simulated reach calculation exceeds the predetermined threshold:
modifying, using the control circuitry, the one or more parameters of the selected machine learning model;
generating, using the selected machine learning model, implemented on control circuitry, a revised simulated reach calculation based on at least the modified one or more parameters; and
in response to the determination that the difference between the sample reach calculation and the revised simulated reach calculation does not exceed the predetermined threshold, storing, in a storage medium, the modified one or more parameters as the machine learning model; and
making available the machine learning model for provision of an on-demand reach calculation request to overcome having to perform direct reach calculations on a full dataset.

52. The method of claim 51, wherein modifying the one or more parameters of the selected machine learning model comprises adjusting a number of advertisements included in the advertising campaign, advertisement frequencies, advertisement schedules, and advertisement channels.

53. The method of claim 51, wherein each of the one or more parameters comprise a mathematical relationship between the simulated reach calculation and the set of aggregated features.

54. The method of claim 53, wherein the mathematical relationship comprises at least one of a quadratic function, a natural exponential function, or an inverse function.

55. The method of claim 51, wherein the machine learning model is selected based on the set of aggregated features.

56. The method of claim 51, wherein the set of aggregated features is based on a user selection.

57. The method of claim 51, wherein the sample size is based on a user selection.

58. The method of claim 51, wherein the predetermined threshold is based on a user selection.

59. The method of claim 51, wherein media consumption comprises at least one of linear programmed media assets or non-linear programmed media assets.

60. The method of claim 51, wherein the sample size is determined using a percentage of a total number of users.

61. A system for providing real-time reach estimation calculations via a machine learning model, comprising:
control circuitry configured to:
retrieve a reduced user data set having a sample size from a full user data set comprising media consumption data for a plurality of users;
generate a set of aggregated features that is predictive of a reach estimation of unique users who are exposed to an advertising campaign during media consumption;
develop the machine learning model by configuring the control circuitry to:
determine a sample reach calculation, wherein the sample reach calculation is based on the set of aggregated features and the reduced user data set;
generate a simulated reach calculation using a selected machine learning model, implemented on the control circuitry, comprising one or more parameters, wherein the machine learning model is selected based on the set of aggregated features and the sample size;
determine whether the difference between the sample reach calculation and the simulated reach calculation exceeds a predetermined threshold;
in response to the determination that the difference between the sample reach calculation and the simulated reach calculation exceeds the predetermined threshold:
modify the one or more parameters of the selected machine learning model;
generate, using the selected machine learning model, implemented on control circuitry, a revised simulated reach calculation based on at least the modified one or more parameters; and
in response to the determination that the difference between the sample reach calculation and the revised simulated reach calculation does not exceed the predetermined threshold, store, in a storage medium, the modified one or more parameters as the machine learning model; and
make available the machine learning model for provision of an on-demand reach calculation request to overcome having to perform direct reach calculations on a full dataset.

62. The system of claim 61, wherein the control circuitry, when modifying the one or more parameters of the selected machine learning model, is configured to adjust a number of advertisements included in the advertising campaign, advertisement frequencies, advertisement schedules, and advertisement channels.

63. The system of claim 61, wherein each of the one or more parameters comprise a mathematical relationship between the simulated reach calculation and the set of aggregated features.

64. The system of claim 63, wherein the mathematical relationship comprises at least one of a quadratic function, a natural exponential function, or an inverse function.

65. The system of claim 61, wherein the machine learning model is selected based on the set of aggregated features.

66. The system of claim 61, wherein the set of aggregated features is based on a user selection.

67. The system of claim 61, wherein the sample size is based on a user selection.

68. The system of claim 61, wherein the predetermined threshold is based on a user selection.

69. The system of claim 61, wherein media consumption comprises at least one of linear programmed media assets or non-linear programmed media assets.

70. The system of claim 61, wherein the control circuitry is configured to determine the sample size using a percentage of a total number of users.
